(19) United States
(12) Patent Application Publication
(10) Pub. No.: US 2003/0021045 A1
(43) Pub. Date: Jan. 30, 2003

(54) Double angle back view mirror

(76) Inventors: Sajid Ali Mirza Khan, Ridgefield Park, NJ (US); Salma Bashir Khan, Ridgefield Park, NJ (US); Furqan Bashir Muhammad, Ridgefield Park, NJ (US); Adil Ali Khan, Ridgefield Park, NJ (US); Sheba Sarwat Khan, Ridgefield Park, NJ (US); Salman Khan, Ridgefield Park, NJ (US)

Correspondence Address: SAJID ALI MIRZA KHAN, 2 UNION PLACE, RIDGEFIELD PARK, NJ, 07660, US

(21) Appl. No.: 10/212,525

(22) Filed: Aug. 1, 2002

Related U.S. Application Data
(63) Continuation-in-part of application No. 09/766,906, filed on Jan. 22, 2001.

(51) Int. Cl. G02B 5/08

(52) U.S. Cl. 359/855; 359/865

(57) ABSTRACT

A rear view double angle mirror for motor vehicles that gives the rearview from two different angles for the driver side and passenger side rear views. Another triple mirror, for the inside of the vehicle that gives the rear view from three different angles. A two inch round, adjustable mirror that glues onto current single rearview mirrors. A two inch round mirror sitting on its own pivot at the outer edge of the larger oval, square or in between larger rearview mirrors for motor vehicles.

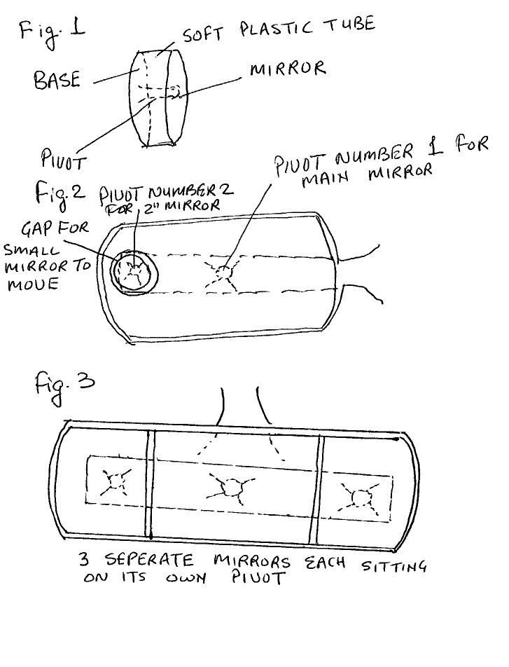

### BACKGROUND OF INVENTION

The current rear view mirrors installed in our motar vehicle are designed to take in the back view from only one angle. These single angle mirrors are dangerous as they leave a blind spot. The blind spot becomes more dangerous when the vehicle makes a left or right turn. In fact almost all large vehicles have two or more mirrors to solve this problem. All small cars continue to have a single angle back view mirror.

### BACKGROUND OF INVENTION—OBJECTS AND ADVANTAGES

This invention relates to removing the blind spot from the single angle rear view mirrors. We have invented a double angle back view mirror. This back view mirror consists of two mirrors of equal size and similar shape, sitting on their own pivots. Both mirrors are placed in a single casing.

The advantages of this double angle mirror in a single casing is that both mirrors can be angled independently of each other. Thus leaving no blind spot for the driver.

### DETAILED DESCRIPTION

(1)This double angle back veiw mirror consists of two mirrors sitting on their own pivots. Said mirrors have the same shape and size. They are either oval, rectangular, or some shape in between. They are placed side by side, horizontally or vertically. Both mirrors are placed in a single casing.

(2)Another way is to convert the current single angle mirrors into double angle mirrors. We have invented a two inch diameter, round mirror that sits on a pivot that is attached to a two inch base. The base and the mirror are attached with a ½ inch soft plastic tube. * Please see diagram. This mirror can easily be glued to all current single angle mirrors.

(3)A rearview mirror that consists of a mirror with a two inch round mirror sitting on its own pivot inside of the outer edge of the back view mirror. *Please see diagram

(4)The inner backview mirror consists of three sections each sitting on its own pivot. Thus the inner rear view mirror covers three different angles. The center mirror is twice the size of the other two mirrors. All of these can be in a single casing or each may have their own casing. *Please see diagram

1. A rearview mirror for motor vehicles that takes in the rearview form two different angles, thus removing any blind spots. Said mirror consists of two mirrors each on its own pivot, placed in a single casing.

2. A two inch diameter, adjustable round mirror, with a base that glues onto existing single angle rear view mirrors. Thus making single angle rear view mirrors into double angle rearview mirrors.

3. A rearview mirror that consists of a mirror with a two inch round mirror sitting on its own pivot inside of the outer edge of the original larger mirror.

4. A backview mirror for the inside of the vehicle that consists of three mirrors. All said mirrors sitting on their own pivot, thus giving the rearview from three different angles.
